(19) United States
(12) Patent Application Publication
(10) Pub. No.: US 2001/0046274 A1
(43) Pub. Date: Nov. 29, 2001

(54) Method and apparatus for the detection of hydrogenous materials

(76) Inventors: Richard A. Craig, West Richland, WA (US); Anthony J. Peurrung, Richland, WA (US)

Correspondence Address: Intellectual Property Service, Battelle Memorial Institute, Pacific Northwest Division, P.O. Box 999, Richland, WA, 99352, US

(21) Appl. No.: 09/771,064

(22) Filed: Jan. 26, 2001

Related U.S. Application Data
(63) Continuation-in-part of application No. 09/561,830, filed on Apr. 28, 2000.

(51) Int. Cl. G01T 1/00

(52) U.S. Cl. 376/154

(57) ABSTRACT

An improved method and apparatus for the detection of hydrogenated materials. Detection of concealed hydrogenated materials such as organic explosives, drugs, or biological tissue is accomplished by measuring the backscattering of neutrons from hydrogenous material in the targeted environment. The system comprises a neutron source that provides information as to the time at which the neutron is emitted, and a neutron sensor, which provides information as to the time at which the neutron is detected and may provide information as to the location at which the neutron is detected. The invention comprises a timing circuit that deactivates the neutron sensor during a time delay to reject signals from neutrons that have not scattered from hydrogen nuclei. The invention may further cease to detect neutrons after a window to reject signals from neutrons that have scattered off distant hydrogen nuclei, which may represent background noise. The device, therefore, preferentially detects thermalized neutrons with resulting enhanced sensitivity. The invention allows for rapid and effective detection of hydrogenated materials that may be hidden from view in the ground, in buildings, vehicles, baggage, or other structures.

### CROSS REFERENCES TO RELATED APPLICATIONS

This application is a continuation-in-part of application Ser. No. 09/561,830 filed Apr. 28, 2000.

### STATEMENT REGARDING FEDERALLY SPONSORED RESEARCH AND DEVELOPMENT

This invention was made with Government support under Contract DE-AC0676RL01830 awarded by the U.S. Department of Energy. The Government has certain rights in the invention.

### FIELD OF THE INVENTION

The present invention is a method and apparatus for the detection of hydrogenous materials, especially concealed hydrogenous materials, including explosives, drugs, and biological tissue. Concealment may be in the form of being buried in the ground or being otherwise hidden from view.

### BACKGROUND OF THE INVENTION

Reliable detection of concealed materials such as explosives and drugs is a critical issue in providing security to both military personnel and the general population. Such detection is a first line of defense against terrorist attacks, landmines and other unexploded ordinance (UXO), and drug smuggling. Landmines and UXO kill or injure thousands each year and are a significant barrier to economic and social development in many parts of the world, seriously affecting daily life in more than 70 countries.

The metal detector, which is based on electromagnetic induction, has been used to detect land mines and UXO. Metal detectors are deficient in several aspects. In the case of UXO, metal detectors provide no differentiation between benign metallic objects and ordinance containing explosive material; that is, they are subject to false positive readings. More importantly, modern mines are encased in plastic and contain little or no metal and are often undetectable by these devices.

Ground-penetrating radar and similarly functioning microwave imaging devices detect underground targets based on the dielectric contrast. Metallic objects have very large dielectric contrast with soils and are easily seen with microwave instruments; plastic objects have smaller contrast and are less easily seen with microwave instruments. In addition, the very large change in dielectric response between the air and soil results in a large reflected signal in which the signal of the target may be hidden.

Nuclear quadrupole resonance (NQR) is also being examined for finding mines or UXO. NQR is much like nuclear magnetic resonance as used in magnetic resonance imaging systems except that it operates without the requirement for an applied magnetic field. In NQR, a radio frequency signal excites nuclei in the target and the frequency of a return signal is characteristic of the chemistry of the target. NQR is an extremely precise method for characterizing the chemical content of a nearby object. NQR signals, however, are typically very weak and subject to interference by other electromagnetic fields. The equipment for NQR is large and measurement times are long.

Prompt neutron-induced gamma-ray spectroscopy (PINS) is being actively investigated for finding mines or UXO. In PINS-like methods, neutrons are sent into the ground and induced gamma rays are examined spectroscopically for evidence of elements contained in explosives. PINS-like methods are an extremely precise method for characterizing the chemical content of a nearby object. Typical measurement times for PINS-like methods, however, are on the order of 10 minutes, impracticably slow for an in-field application (G. Nebbia et al, “The Explodet Project: Advanced Nuclear Techniques for Humanitarian Demining,” 6th International Conference on Applications of Neutron Science, June 1999, Crete and P. C. Womble et al, “Landmine Identification Using Pulsed Fast-Thermal Neutron Analysis,” 6th International Conference on Applications of Neutron Science, June 1999, Crete).

An important feature in common for most explosives and drug contraband is that these materials contain hydrogen and consequently are able to be detected with another neutron technique of neutron scattering. For example, neutron scattering has been used to detect plastic mines (F. D. Brooks and A. Buffler, “Detection of Plastic Land Mines by Neutron Backscattering,” 6^{th} International Conference on Applications of Neutron Science, June 1999, Crete). In this approach, a fast neutron source and thermal neutron sensor in close proximity were used. The presence of a mine was indicated by thermal neutron signals caused by scattering and moderation of fast neutrons in the presence of hydrogen. This approach, however, has an inferior signal-to-noise ratio because fast neutrons emitted by the source or backscattered directly from the soil, although poorly detected by the thermal neutron sensor, greatly outnumber the thermal neutron signals. Thus, although this concept is amenable to incorporation in a small, lightweight instrument, the background noise is relatively large so detection efficacy is poor.

Similarly, attempts to image buried hydrogenous material (e.g., a simulated plastic land mine) using neutron scattering techniques have been made using coded-aperture techniques and high-spatial precision, pressurized He-3 detectors. Because the background noise, associated with detection of fast neutrons, is appreciable, the image quality is less than satisfactory (Peter Vanier and Leon Forman, “Advances in Imaging With Thermal Neutrons”, Proceedings of the Institute of Nuclear Materials Management, 37th Annual Meeting, Naples, Fla., July 1966). An alternative approach to imaging is provided by Peurrung et al. (A. J. Peurrung, P. L. Reeder, E. A. Lepel, and D. C. Stromswold, “Location of neutron sources using moderator-free directional thermal neutron detectors”, IEEE Transactions on Nuclear Science, Vol 44, number 3, part 1, pp 563-7, July 1997). In this approach, a large aspect-ratio collimator in front of a position-sensitive neutron detector was used. Again, however, the background noise associated with detection of fast neutrons degrades the quality of the image.

Accordingly, there is a continuing need for a low-noise and sensitive device for detecting objects containing hydrogenous material.

### BRIEF SUMMARY OF THE INVENTION

The present invention is an improved method and apparatus that employs both neutron scattering and time-tagged neutron techniques to address such types of needs. Time-tagged neutron techniques have been used in a number of applications in the past for identification of nuclear weapons or nuclear materials (T. Uckan et al, “²⁵²Cf-source-correlated transmission measurements for uranyl fluoride deposit in a 24-in-OD process pipe,” Nuclear Instruments and Methods in Physics Research, 1999, 26-34). Time-tagged neutron systems make a gating or timing signal available to neutron sensor(s) based on the point in time at which a neutron leaves the source. In these nuclear applications, the time-tagged neutron source is used as a marker to measure response of a target to neutrons and gamma-rays. The fast (nanosecond-scale) time-correlated time-of-flight gamma-ray and neutron transmissions through, and reactions with, the target provide a means for distinguishing between various fissile material assemblies. Such time-tagged sources are commonly fabricated by incorporating a neutron source, such as ²⁵²Cf, into a fission chamber.

Another source for time-tagged neutrons is a neutron generator, which is commonly constructed by accelerating deuterium nuclei and reacting these with either other deuterium nuclei or tritium nuclei. Such generators can be operated either in the pulsed or continuous mode. In the pulsed mode, these provide a time-correlated source of neutrons. Portable neutron generators are commonly available with outputs of up to 10⁶n/pulse but can be operated at smaller outputs.

The present invention detects hydrogenous materials by measuring the backscattering of neutrons emitted from a neutron source that have been slowed to thermal regime velocities (thermalized) by their interaction with hydrogen atoms in the targeted environment. The sensitivity of the detector has been greatly enhanced by utilizing time-tagged neutrons and a timing circuit in the control system. This timing circuit prevents the counting or detection of unwanted “prompt” neutrons (e.g., by disabling the neutron sensor) during a first time interval after the emission of the neutrons from the neutron source is detected and allows detection of neutrons thereafter (this first time interval is hereinafter referred to simply as “time delay”). The sensitivity of the detector may be further enhanced by having the timing circuit allow the counting or detection of neutrons during a second time interval that follows the time delay and prevent the counting or detection of neutrons after this second time interval (this second time interval is hereinafter referred to simply as “window”). Utilization of such a window prevents the detection of neutrons that have been moderated by hydrogen far from the detector (e.g., moisture in surrounding soil) and thus, reduces noise.

The detector of the present invention, therefore, does not register any neutrons that return to the neutron sensor during the time delay. Most neutrons returning during this time (i.e., “prompt neutrons”) are fast neutrons that were not scattered from hydrogenous materials and produce unwanted background noise. The detector may further not register any neutrons that return to the neutron sensor after an employed window. Most neutrons returning after the window (i.e., “late neutrons”) are slow neutrons that have been thermalized far from the neutron sensor and migrate in to produce additional unwanted background noise. This effect is most pronounced when the hydrogen content far from the sensor (e.g., moisture in the surrounding soil) is greatest.

Further improvement in the signal-to-noise ratio is achieved when the neutron sensor in the detector comprises a gas-proportional counter tube and applying pulse-height discrimination to the detected neutron signal. Discriminating against small signals is standard practice for reducing electronic noise; using an upper-level discriminator to discriminate against large signals, however, provides discrimination against fast neutrons coming directly from the neutron source in the detector or arising from backscatter.

The detector of the present invention may be moved or scanned over a targeted area such as soil or ground. The detector may be operated in a count mode, image mode, or combination thereof. In the count mode, an increase in detection rates of thermalized neutrons by the detector indicates the presence of hydrogenous material. Alternatively, in the image mode, a visual spacial representation of any increased detection rate of thermalized neutrons is provided to the user.

Imaging for the detection of hydrogenous material is based on the assumption that the last scattering position of a near-thermal neutron is at, or near, the hydrogenous material. This assumption is physically reasonable—the mean path between collisions for a slow neutron (less than 500 times as fast as a fully thermalized neutron) in RDX (a commonly-used explosive) for instance, is a little less than 0.8 cm; in dry sand it is about 4 cm. Thus, the slow neutrons will most likely appear to emanate from the target.

There are several approaches to spatially resolving the neutron count signal, or in another words, providing the spatial location of the target. The simplest approach is a modification of a quasi-imaging approach that has been used in astronomy for determining the locations of x-ray and gamma-ray sources and adapted for neutrons by Peurrung et al; this is simply a large-open-area collimator that restricts the angle at which neutrons can enter the detector. Peurrung et al have shown that a honeycomb structure can perform this function quite well. The collimator should be constructed of a material that absorbs slow neutrons well and slows neutrons poorly.

In this approach, the thermal neutron detector also needs to have the ability to report the position at which the neutron is detected. The collimator limits the direction from which the slow neutrons may be coming; a position-sensitive detector will provide source-shape information. ³He tubes inherently have a position-sensitivity capability in one dimension with a resolution equal to approximately their diameter; resistive-wire tubes can provide this kind of information in two dimensions. If greater precision is desired, the neutron detection can be done with crossed scintillating fibers, which could provide sub-millimeter resolution. This quasi-imaging approach will reduce the effect of inhomogeneities in moisture content and will reduce the halo or penumbra effect in which a target off the axis of the detector affects the count rate of the detector. By reducing the effect of off-axis neutrons, the signal-to-noise ratio will also improve. Because signal neutrons are also being attenuated, more measurement time, to provide adequate signal per pixel, may be required.

True imaging, in which off-axis neutrons as well as near-axis neutrons contribute to the image, can be achieved by forming a pinhole camera, or its modern equivalent, a coded-aperture camera using the techniques of Vanier and Forman. A coded-aperture camera is a many-pinhole pinhole camera in which the image is reconstructed computationally. The open area of a coded-aperture camera can be 50% of the front surface; potentially the utilization of the slow backscattered neutrons can be much greater than that that for a simple collimated system. This approach requires much greater complexity for the physical and electronic parts of the system.

In yet another implementation, if the imaging capability is included, the detector may be moved or scanned over a targeted area in a nonimaging counting mode, and, when a suspicious area is found, converted to imaging mode to provide an image of the objects generating the signal. This operational mode provides for rapid scanning and slower but high-confidence confirmation of the target.

The present invention has substantial advantages over prior methods for the detection and imaging of concealed explosives, drugs and other hydrogenous materials including biological tissue in relatively inorganic environments. The time-tagged neutron source, together with judicious selection of the time delay, the size of any window, and any lower and upper discriminator levels, greatly increases the signal-to-noise ratio making the sensitivity for detecting hydrogenous materials greater than previous detectors. The detector is rugged and lightweight (man-portable) and provides a fast response time compared to other methods.

An object of the present invention is to improve the detection sensitivity, and image quality, of concealed hydrogenous materials, including explosives and drugs.

A further object of the present invention is to improve the ability to detect low- or non-metal land mines.

A further object of the present invention is to improve the ability to detect contraband.

A further object of the present invention is to improve the ability to detect human or animal remains.

### BRIEF DESCRIPTION OF THE DRAWINGS

FIG. 1a is a cross-sectional side view of a schematic representation of an embodiment of the present invention whereby the detector is handheld;

FIG. 1b is a cross-sectional side view of a schematic representation of another embodiment of the present invention whereby the detector is mounted on a vehicle;

FIG. 2a is a cross-sectional side view of a schematic representation of a collimated sensing head that may be used in an imaging mode;

FIG. 2b is a bottom view of the collimated sensing head shown in FIG. 2a;

FIG. 3a is a cross-sectional side view of a schematic representation of a coded-aperture sensing head that may be used in an imaging mode;

FIG. 3b is a bottom view of the coded-aperture sensing head shown in FIG. 3a;

FIG. 4a is a cross-sectional side view of an experimental setup for testing time delays of the present invention;

FIG. 4bis a magnified view of the sensing head used in the experimental setup of FIG. 4a;

FIG. 4c is a schematic representation of the electronic circuitry used in the experimental setup of FIG. 4a;

FIG. 5ais a cross-sectional side view of an experimental setup for testing time delays and pulse-height discrimination of the present invention;

FIG. 5bis a magnified view of the sensing head used in the experimental setup of FIG. 5a;

FIG. 5c is a schematic representation of the electronic circuitry used in the experimental set up of FIG. 5a;

FIG. 6a is a chart showing a pulse-height spectrum obtained from the testing using the experimental setup of FIG. 5a;

FIG. 6b is a chart showing the detection efficiency as a function of lower-level discriminator with no upper-level discriminator for 100-s count obtained from testing using the experimental setup of FIG. 5a;

FIG. 6c is a chart showing the detection efficiency as a function of upper-level discriminator with lower-level discriminator at channel 39 for 100-s count obtained from testing using the experimental setup of FIG. 5a;

FIG. 7a provides a cross-sectional side view of the physical model used in the computer model;

FIG. 7b is a magnified view of a section of the computer model of FIG. 7a;

FIG. 7c is a chart showing the detection efficiency as a function of the time delay using the computer model of FIG. 7a;

FIG. 7d is a chart showing the improvement of detection efficiency as a function of the time delay using the computer model of FIG. 7a;

FIG. 7e is a chart showing the detection efficiency as a function of the time delay using the computer model of FIG. 7a with the target 1 cm deep;

FIG. 7f is a chart showing the improvement of detection efficiency as a function of the time delay using the computer model of FIG. 7a with the target 1 cm deep;

FIG. 7g is a chart showing the detection efficiency as a function of the time delay using the computer model of FIG. 7a with the target 2.5 cm deep;

FIG. 7h is a chart showing the improvement of detection efficiency as a function of the time delay using the computer model of FIG. 7a with the target 2.5 cm deep;

FIG. 7i is a chart showing the detection efficiency as a function of window size using the computer model of FIG. 7a with the target 1 cm deep;

FIG. 7j is a chart showing the improvement of detection efficiency as a function of window size using the computer model of FIG. 7a with the target 1 cm deep;

FIG. 7k is a chart showing the detection efficiency as a function of window size using the computer model of FIG. 7a with the target 2.5 cm deep;

FIG. 7l is a chart showing the improvement of detection efficiency as a function of window size using the computer model of FIG. 7a with the target 2.5 cm deep;

FIG. 7m is a chart showing the detection efficiency as a function of window size using the computer model of FIG. 7a with dry soil; and

FIG. 7n is a chart showing the improvement of detection efficiency as a function of window size using the computer model of FIG. 7a with dry soil.

### DETAILED DESCRIPTION OF THE INVENTION

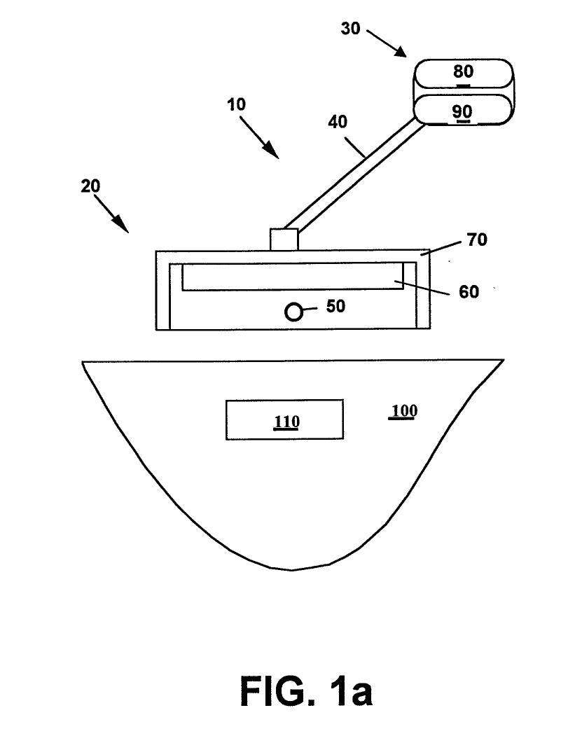

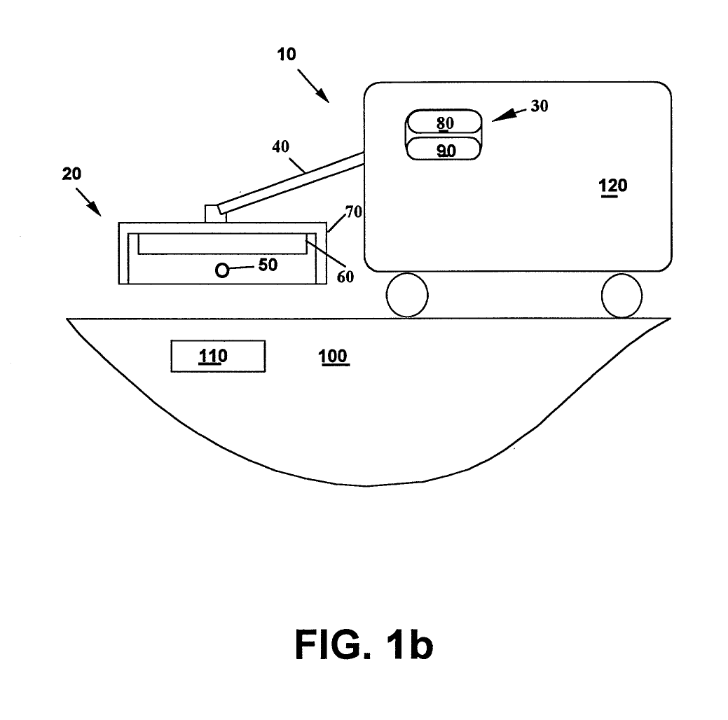

The present invention is a method and apparatus for detecting hydrogenous materials, especially materials concealed in relatively inorganic environments, by measuring the backscattering of neutrons that have been thermalized by their interaction with hydrogen atoms. In one embodiment of the present invention, shown schematically in FIG. 1a, the detector 10 is a handheld device. The detector 10 has at least one sensing head 20, which may be a simple counting device, a device for imaging, or one performing both functionalities. The sensing head 20 comprises a neutron sensor 60 (hereinafter referred to simply as “sensor”) and a neutron shield 70. As shown in the embodiment of FIG. 1a, a time-tagged neutron source 50 (hereinafter referred to is simply as “source”) may be physically colocated with the sensing head 20, though the present invention is not limited to such configurations. For example, the source 50 may be physically separated from the sensing head 20 to provide a stream of neutrons toward a suspected hydrogenous material that are subsequently backscattered from the material to the sensing head 20. The detector 10 further comprises a control system 30 that may be physically connected to the sensing head 20 and source 50 by way of an extension arm 40. The control system 30 comprises a user interface 80 and electronic circuitry 90. The electronic circuitry for the sensing head 20, source 50, and user interface 80 includes the necessary power supplies, amplifiers, timing circuit, and other electrical components. The user interface 80 provides the means for communicating the measurement results to the user. The signal from the sensor 60, dependent on the amount of hydrogenous material detected, is sent to the user interface 80 by way of the electronic circuitry 90. The user interface 80 may include, but is not limited to, an audible enunciator (e.g., alarm, variable-sounding horn), an analog or digital meter or display, a mechanical vibrator, and combinations thereof.

In one embodiment, the electronic circuitry 90 disables the sensor 60 during a time delay after the emission of a neutron from the source 50 is detected and enables the sensor 60 thereafter. In another embodiment, the electronic circuitry 90 disables the sensor 60 during a time delay after the emission of a neutron from the source 50 is detected, then enables the sensor 60 during a window, and then disables the sensor 60 thereafter. The extension arm 40 physically supports the sensing head 20 and control system 30 while providing an electrical conduit between these two components. The sensing head 20 may be moved over the ground 100 to scan an area proximate a suspected target 110. An increase in detection rates of thermalized neutrons by the sensor 60 indicates the presence of hydrogenous materials. In the imaging mode, a region causing increased scattering of detected neutrons indicates a greater than ambient concentration of hydrogen.

An alternative embodiment of the present invention is shown schematically in FIG. 1b whereby the detector 10 comprises a scanning vehicle 120 and, as above, has at least one sensing head 20 and a control system 30. Multiple sensing heads 20 may be arranged and mounted directly on the scanning vehicle 120 or arranged and mounted on one or more extension arms 40 to form an array for efficient scanning. A variation of this embodiment is whereby the sensing head 20 comprises one or more sources 50 with one or more sensors 60 and a neutron shield 70. Such a detector would be suitable where large areas need to be scanned and/or remote operation was required. If remote operation is required, the user interface 80 may comprise a wireless transmitter that communicates the presence of a hydrogenous material to a user at a remote receiving station.

The present invention is not limited to the embodiments specifically shown in FIGS. 1a-b and is not limited to applications that require scanning of the ground 100. For example, the target 110 may be hidden from view in buildings, vehicles, baggage, or other structures. Furthermore, as is known to those skilled in the art, the specific locations for the electronic circuitry 90 and user interface 80 may be different and quite variable depending on specific user requirements and detector applications. Yet further, the extension arm 40 may or may not be required and may be designed using a variety of geometries.

In both embodiments of FIGS. 1a-b, neutrons emitted from the source 50 have a variety of fates. Some neutrons will go directly from the source 50 to the sensor 60 and either pass through the sensor 60 or react within the sensor 60, giving a detection signal. Because the majority of emitted neutrons are fast, these events will occur very quickly after emission. Some neutrons will collide with heavy nuclei in the ground 100 and, after one or more collisions, pass back to the sensor 60. Because these collisions are with heavy nuclei, compared to the hydrogen nuclei, the neutron loses little of its speed so that detection events with these interactions will occur quickly after emission. A few of the neutrons will collide with a hydrogen nucleus, either in an initial collision or subsequent to a collision with a heavier nucleus. Such neutrons will be slowed substantially; those that make several collisions with hydrogen nuclei will be slowed sufficiently that they have a high probability of detection in the sensor 60. Because the hydrogen slows the neutron substantially, detection events for these will occur considerably later after emission than events from neutrons passing directly to the sensor 60 or after collision with the ground 100, which have not been slowed.

Thus, if only those detection events that occur after the judiciously selected time delay are counted, the relative efficiency of detection of neutrons that have interacted with hydrogen, compared to those that have not interacted with hydrogen, is improved. This preferential detection of thermalized neutrons, after the time expected for their interaction and return from hydrogen nuclei located in the immediate vicinity of the source and detector, results in an improved ability to rapidly distinguish concentrations of hydrogenous materials such as organic explosives.

The source 50 may be any of the following:

(1) a fission source that provides a distinct electronic signal for each fission event resulting in the emission of a neutron, such as ²⁵²Cf or other spontaneously fissioning nucleus in a fission chamber, or

(2) a fission source that provides a distinct electronic signal for each fission event resulting in the emission of a neutron and discriminating against other decay modes, such as ²⁵²Cf or other spontaneously fissioning nucleus together with a scintillator, sensing the multitude of gamma rays emitted simultaneously with the neutron during the fission event, or

(3) a neutron generator, operated in pulse mode, such as the Model A-801 sold by MF Physics of Colorado Springs, Colo., in which ions are accelerated onto a target, the product of which is neutrons, or

(4) an (alpha, n) source, contained within a cross-luminescing scintillator system such that each (alpha, n) reaction produces an electronic signal distinguished from alpha particle scintillations that produce no neutrons, or

(5) a pulsed (gamma, n) source or (x-ray, n) source, producing prompt photoneutrons from a target such as beryllium.

Thermal-neutron sensors operate on the basis of a nuclear reaction in which the neutron is absorbed by a nucleus, such as ⁶Li, ¹⁰B, or ³He. In such reactions an energetic and massive particle, often an alpha particle or a tritium (³H) nucleus, is emitted. The energy associated with the reaction provides a means for detection of the reaction. These reactions have greater probability of occurrence for thermal neutrons than for fast. The reaction probability varies approximately inversely with the velocity of the neutron. This means that fast neutrons have a possibility, albeit small, for engaging in the detection reaction. However, the much greater number of fast neutrons means that these contribute to the count rate of the detector.

The sensor 60 should be a detector whereby the efficiency and sensitivity is greater for slower neutrons compared to faster neutrons, for example any of the following:

(1) a ³He gas-proportional counter, or

(2) a ¹⁰BF₃ gas-proportional counter, or

(3) a ⁶Li containing scintillating glass or scintillating glass fiber, or

(4) a ⁶Li or ¹⁰B containing scintillating plastic or scintillating plastic fiber, or

(5) a ⁶Li or ¹⁰B containing scintillating crystal, or

(6) any combination of the foregoing.

In an imaging implementation, the sensor 60 should have the ability to determine the position at which the neutron was detected. This may be achieved, for example, by using a multi-wire, ³He or ¹⁰BF₃ gas-proportional counter, by using an array of resistive-wire, ³He or ¹⁰BF₃ gas-proportional counters, by using an array of neutron-sensitive, scintillating glass or scintillating plastic fiber, connected to photomultiplier tubes in such a way that the position of the neutron interaction is detected and reported, or some combination of the above.

The neutron shield 70 should be an efficient absorber of thermal neutrons, for example, any of the following:

(1) a ¹⁰B-containing material, or

(2) a ⁶Li-containing material, or

(3) a Cd-containing material, or

(4) a Gd-containing material, or

(5) any combination of the foregoing.

All other things being equal, neutron shield 70 materials such as (1) or (2) above are preferable because these also serve to provide some shielding for faster neutrons. Furthermore, it is preferred that the neutron shield 70 be fabricated of non-hydrogenous material because any hydrogen in the vicinity of the source 50 or sensor 60 will serve to increase the noise associated with fast neutrons moderated by the neutron shield 70 versus the targeted hydrogenous material.

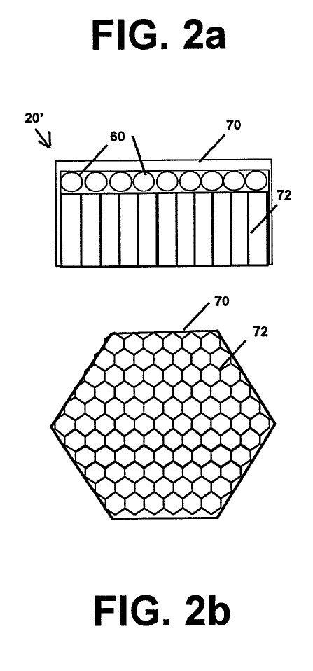

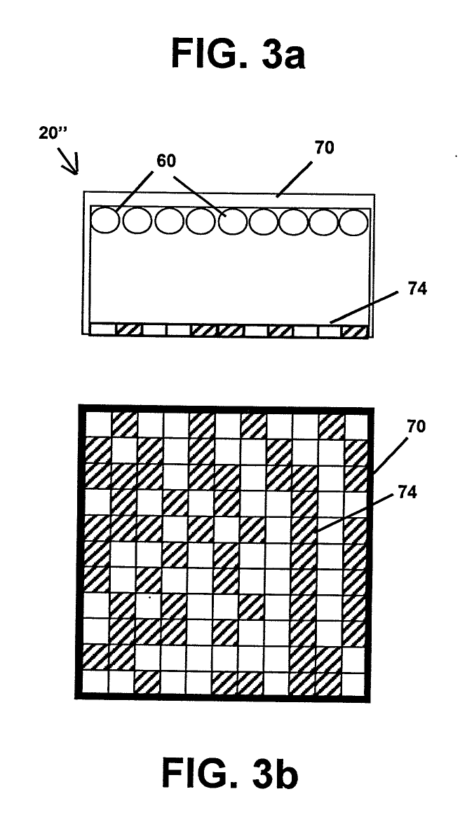

Imaging may be performed on the basis of using a sensing head 20′ comprising a collimating material 72 as shown in FIGS. 2a-b or a sensing head 20″ comprising a coded-array aperture 74 as shown in FIGS. 3a-b. The collimating material 72 or the material forming the basis of the coded-array aperture 74 should be an efficient absorber of thermal neutrons, for example, any of the following:

(1) a ¹⁰B-containing material, or

(2) a ⁶Li-containing material, or

(3) a Cd-containing material, or

(4) a Gd-containing material, or

(5) any combination of the foregoing.

All things being equal, the collimating material 72 such as (1) or (2) are preferred because these also serve to provide some shielding for faster neutrons. Material such as (3) or (4) material are prefered for the basis of the coded-array aperture 74 because these are less likely to erroneously encode information about the source position of a fast neutron.

### EXAMPLE 1

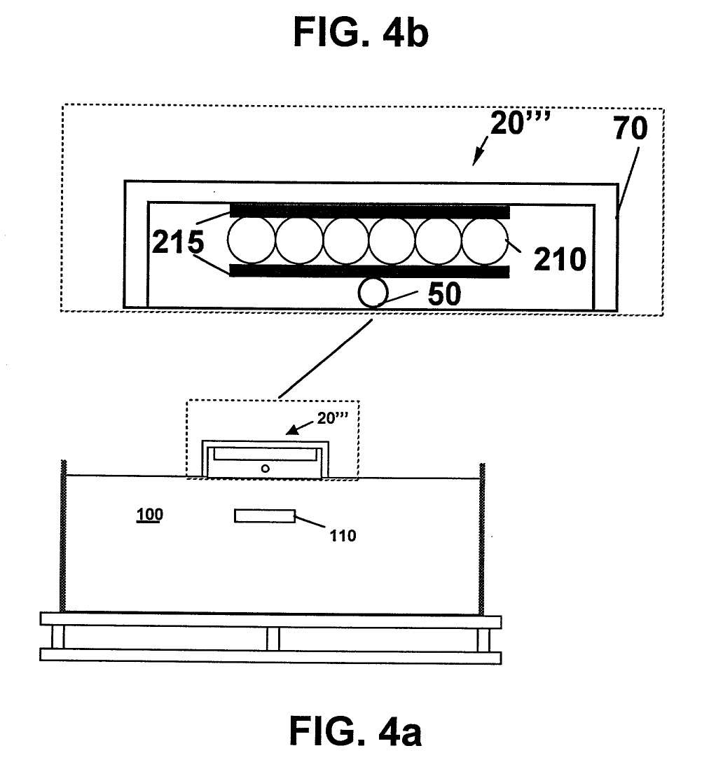

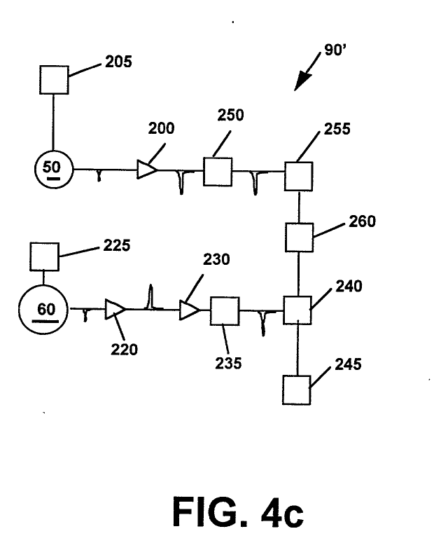

An experimental setup for demonstrating the effect of using a time delay of the present invention is shown in FIGS. 4a-b. The electronic circuitry 90′ used for this experimental setup is shown in FIG. 4c. The present invention is not limited to the specific design of electronic circuitry 90′ of FIG. 4c since it is apparent to those skilled in the art of electronic circuits that alternative circuitry and components could be used to provide the necessary power, controls, and time delay. In this setup, the source 50 was a ²⁵²Cf fission source fabricated for Oak Ridge National Laboratory with a Model Q6456-1 preamplifier 200 made by RIS Corporation. High voltage for the source 50 was provided by an Ortec Model 556 power supply 205 at +400 V (high voltage for the source 50 was supplied through the Q6456-1 preamplifier 200). Power for the preamplifier 200 was supplied by a Tektronics PS280 power supply operating at +15V (not shown).

It is preferred that the sensor 60 is resistant to gamma-ray radiation, because it will be operating in a gamma-ray environment. In this setup, the sensor 60 comprised a ³He gas-proportional counter consisting of six, 0.4053 megaPascal, 2.54-cm diameter, Reuter-Stokes (RS-P4-0814-207) tubes 210 with 36 cm of active length held between two aluminum plates 215. A model 142PC preamplifier 220 fabricated by Ortec was used with the sensor 60. High voltage for the ³He gas-proportional counter was provided by an Ortec Model 456 power supply 225 operating at +1100 V (high voltage for the ³He tubes was supplied through the 142 PC preamplifier 220).

The neutron shield 70 was made from sheets of metallic Cd and had a total thickness of approximately 0.1 cm. It is preferred that the neutron shield 70 is made of boron, lithium, or combinations thereof because these materials attenuate neutrons over all energy ranges.

As shown in FIG. 4c, the signal from the ³He gas-proportional counter preamplifier 220 was sent to an Ortec 571 amplifier 230 and thence to an EG&G CF8000 constant-fraction discriminator 235; those pulses more negative than −0.120 V were sent to two Ortec 772 counters 240 slaved to an Ortec 773 counter/timer 245.

The signal from the source preamplifier 200 was sent to another bay of the EG&G CF8000 constant-fraction discriminator 250; those pulses more negative than −0.108 V, which was found to include essentially all fission events, were sent to an Ortec 416A gate and delay generator 255; the positive signal from this unit was sent to a BNC 7010 digital delay (not shown because multiple delays were only required to examine the effects of variation in delay), thence to a signal complement generator (fabricated in-house, also not shown because it was only required to invert the gate), to an Ortec 427A delay 260, for conditioning, and finally to the gate of one of the Ortec 772 counters 240.

Various time delays are possible; 5 microseconds was found to be best in this experiment. The time delay efficacy maximum was found to be broad so other time delays would provide only minor degradation of efficacy. In other experiments, slightly shorter delays were used with no apparent degradation of performance.

The experimental setup provided two signals: a count (for a period determined by the timer) of the total number of neutrons detected (“ungated”) and the total number of neutrons detected after a time delay (“gated”). For the preferred embodiment, electronic circuitry 90′ providing substantially similar functions to those in this experiment would be used, except that there is no need for the ungated signal, because the ungated signal was only used as a diagnostic comparison for the efficacy of the time-tagged approach.

The experimental setup of FIGS. 4a-c consisted of a series of 100-sec counts with the sensing head 20′″ near the surface of ground 100 simulated using silica sand bed. The experiment consisted of placing the sensing head 20′″ above the surface of the ground 100 with no target 110 present and with a target 110 located at various depths (top surface of the target 110 to the ground 100 surface) ranging from approximately −2.54 cm (lying on the surface) to buried 17.78 cm beneath the surface. Targets included:

300-gram polyethylene disk

a 86.5-g simulated land mine

a 215-g simulated land mine

a 499-g simulated land mine

The simulated mines were fabricated for the U.S. PM-Mines, Countermine and Demolitions (PM-MCD) at Fort Belvoir, Va. by VSE Corporation of Alexandria, Va. to provide a consistent basis for comparing detection technologies.

With the detection signal defined as the difference in number of counts between when a target is present and when it is absent, compared to the expected variance when the target is absent (this detection signal is expressed as n-sigma), time-tagging with a time delay consistently provided an improvement of approximately a factor of 1.9, that is, the detection signal was approximately 1.9 times as great when time-tagging with a time delay was used than when it was not used. For example, when the 300-g polyethylene disk was used, the results listed in Table 1 were obtained. Table 1 shows that the ratio of counts when the target was present to that when it was absent was substantially greater (improved) when time-tagging with a time delay was used. This affirms the value of the method for detection of hydrogenous material. The results of Table 1, interpreted in terms of detection efficiency using a statistical measure, are shown in Table 2.

TABLE 1
Counts/Second
(counts per 100-sec interval divided by 100,
detector 1.9 cm above silica sand)

| | | | Ratio of signal | Ratio of signal |
|---|---|---|---|---|
| Depth | Counts | Counts | with target to | with target to |
| (cm) | ungated | gated | without (ungated) | without (gated) |
| no target | 71.58 | 12.44 | n.a. | n.a. |
| 0 | 1134.29 | 824.42 | 15.85 | 66.27 |
| 2.54 | 639.47 | 454.43 | 8.93 | 36.53 |
| 5.08 | 411.55 | 279.79 | 5.75 | 22.49 |
| 7.62 | 295.01 | 189.66 | 4.12 | 15.25 |
| 10.16 | 196.62 | 111.80 | 2.75 | 8.99 |
| 17.78 | 110.83 | 41.87 | 1.55 | 3.37 |

TABLE 2
Detection Efficiency
(number of sigma greater than noise, detector 1.9 cm above silica sand)

| Depth | | | Gated/Ungated |
|---|---|---|---|
| (cm) | Ungated | Gated | Ratio |
| 0 | 125.6 | 230.2 | 1.8 |
| 2.54 | 67.1 | 125.3 | 1.9 |
| 5.08 | 40.2 | 75.8 | 1.9 |
| 7.62 | 26.4 | 50.3 | 1.9 |
| 10.16 | 14.8 | 28.2 | 1.9 |
| 17.78 | 4.6 | 8.3 | 1.8 |

The gated/ungated ratio of approximately 1.9 in detection efficiency is extremely significant. For instance, a 1-sigma detection means that there is approximately a 68% probability that the signal is caused by a target rather than a statistical variation; at 1.9-sigma there is nearly a 95% probability that the signal is caused by a target. The data in Table 2 provide a quantitative description of the efficacy of the use of time-tagging with a time delay.

### EXAMPLE 2

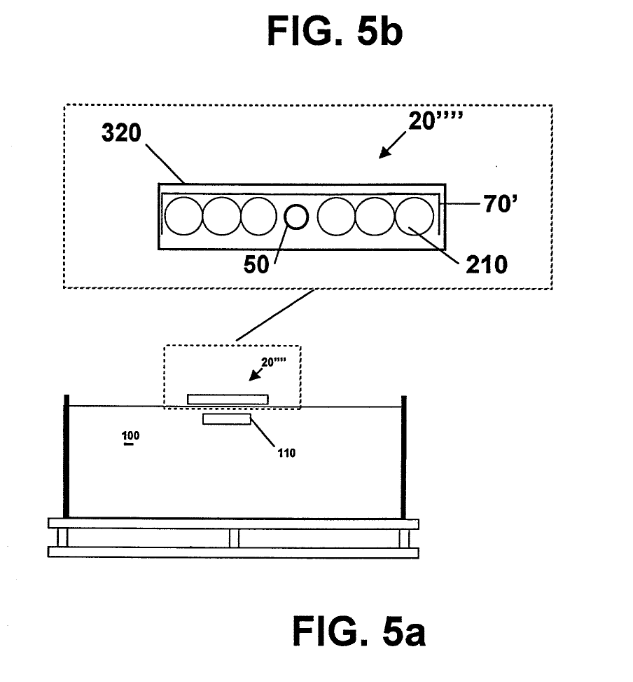

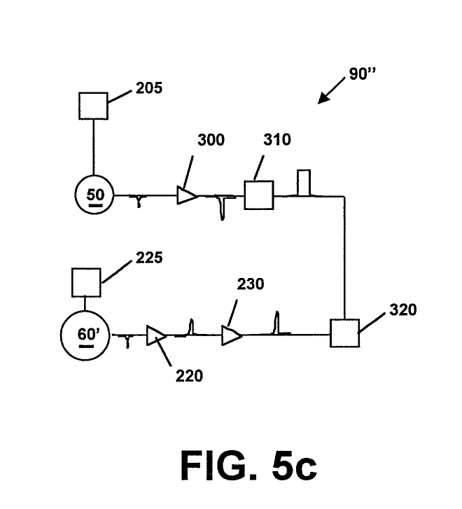

An experimental setup for demonstrating the efficacy of the present invention with pulse-height discrimination is shown in FIGS. 5a-b. Although this example demonstrates that pulse-height discrimination alone improves the signal-to-noise ratio, and, therefore, the detection efficacy, it further demonstrates that use of pulse-height discrimination in conjunction with a time delay provides greater improvement in signal-to-noise ratio than either taken separately. The electronic circuitry 90″ used for this experimental setup is shown in FIG. 5c. The present invention is again not limited to the electronic circuitry 90″ of FIG. 5c since it is apparent to those skilled in the art of electronic circuits that alternative circuitry and components could be used to provide the necessary power, controls, and timing circuit.

The source 50 was a ²⁵²Cf fission source fabricated for Oak Ridge National Laboratory with an Model 10A, amplifier discriminator, 300, manufactured by Precision Data Technology. . High voltage for the source 50 was provided by an Ortec Model 556 power supply 205 at +400 V (high voltage for the source 50 was supplied through the amplifier discriminator 300). Power for the amplifier discriminator 300 was taken from the high-voltage supply 205. Signals from the source 50 were sent to an Ortec Model 416 Gate/Delay generator 310 which provided a 5-microsecond pulse.

The sensor 60′ comprised a ³He gas-proportional counter consisting of six, 0.4053 megaPascal, 2.54-cm diameter, Reuter-Stokes (RS-P4-0814-207) tubes 210 with 36 cm of active length mounted in an aluminum box 320. The source 50 was mounted between the tubes with three tubes on each side. A model 142PC preamplifier 220 fabricated by Ortec was used with the sensor 60′. High voltage for the ³He gas-proportional counter was provided by an Ortec Model 456 power supply 225 operating at +1100V (high voltage for the ³He tubes was supplied through the 142 PC preamplifier 220).

For this experiment, the neutron shield 70′ was made from sheets of metallic Gd and had a total thickness of approximately 0.01 cm. It is preferred, however, that the neutron shield 70′ is made of boron, lithium, or combinations thereof because these materials attenuate neutrons over all energy ranges.

As shown in FIG. 5c, the signal from the ³He gas-proportional counter preamplifier 220 was sent to an Ortec 571 amplifier 230, operating with a shaping time of 2 microseconds, and thence to a Nomad pulse-height analyzer 320; the 5-microsecond pulse from the gate/delay generator 310 was fed to the pulse-height analyzer 320 for coincidence counting.

When a neutron interacts with ³He in a gas-proportional counter, it creates a ⁴He compound nucleus in an excited state which decays to a ³H nucleus with the emission of a proton. The proton creates ion pairs (electrons and positively charged ions) that are collected on the cathode and anode. The number of ion pairs collected, which determines the proportional counter pulse height, is directly related to the energy of the proton and ³H nucleus. In turn, this energy is equal to the sum of the reaction energy, 0.764 MeV, and the kinetic energy of the incoming neutron. Thus, the pulse-height spectrum, contains a limited amount of information about the energy spectrum of the incident neutron.

The pulse-height analyzer 320 separated the pulses, by pulse height, into height bins (channels) although not all channels reported data (the maximum channel was set to be well above the pulse-height region of interest so as to be certain to capture all the significant data. The lower-level discriminator setting on the pulse-height analyzer 320 was set sufficiently low such that noise signals below neutron-detection signals were included. Data from the pulse-height analyzer 320 was sent to a portable computer for logging (not shown).

The experimental setup was operated, for testing purposes, in two modes: a count (for a live-time period determined by the pulse-height analyzer 320) of the total number of neutrons detected (“ungated”) and the total number of neutrons detected during the period of the 5 microsecond pulse (“coincidence”). Data for the anticoincidence mode (“gated”) was derived by channel-wise subtraction of the coincidence data from the ungated data.

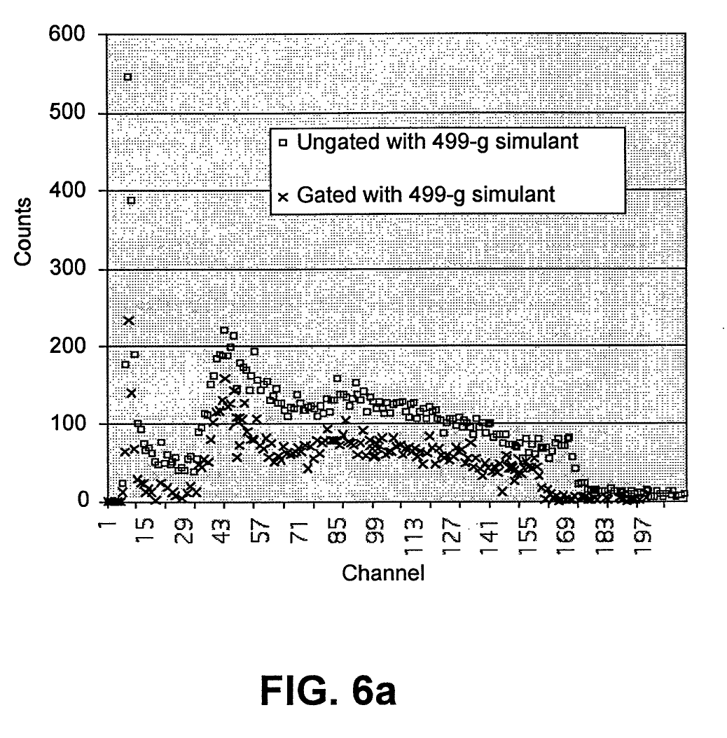

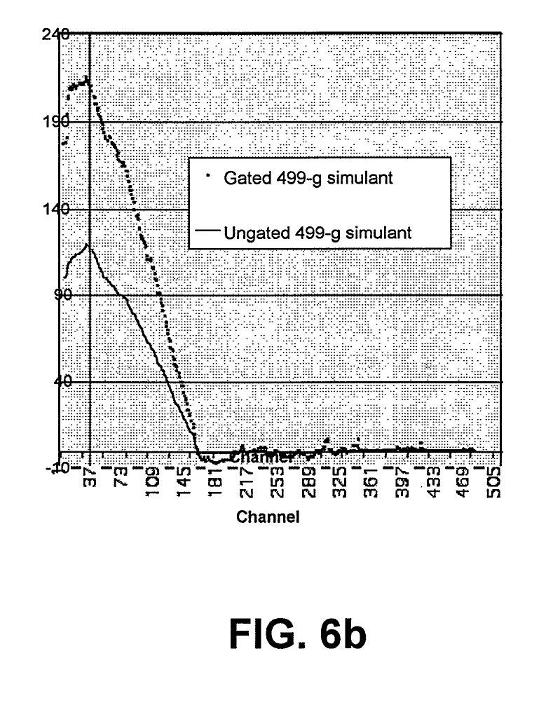

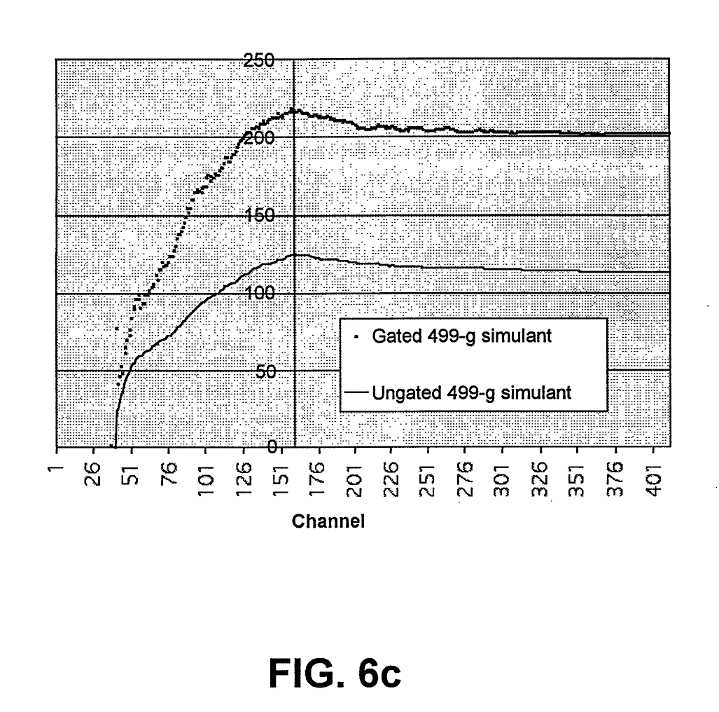

The testing using the experimental setup of FIGS. 5a-c consisted of a series of 100-sec pulse-height spectra counts (FIG. 6a) with the sensing head 20″″ near the surface of the ground 100 simulated using a silica sand bed. The experiment consisted of placing the sensing head 20″″ above the surface (4.44 cm) of the ground 100 with no target 110 present and with a target 110 located flush with the surface. Targets included:

a 215-g simulated land mine

a 499-g simulated land mine

The simulated mines were fabricated for the U.S. PM-Mines, Countermine and Demolitions (PM-MCD) at Fort Belvoir, Va. by VSE Corporation of Alexandria, Va. to provide a consistent basis for comparing detection technologies.

Two analysis techniques were adopted, respectively, to test the effect of a lower-level discriminator setting and an upper-level discriminator setting. To test the effect of the lower-level discriminator setting, a cumulative total of the number of counts, with and without mine simulant targets, was calculated starting at the highest channel. The detection signal, defined as the difference in number of counts between when a target is present and when it is absent, compared to the expected variance when the target is absent (this detection signal is expressed as n-sigma), for this set of experimental conditions, showed (FIG. 6b) a distinct maximum at or near channel 39 for both time-tagged cases and cases in which time tagging is not used. This simply means that data below about channel 39 add more noise than signal and should not be used. This provides guidance that the lower-level discriminator setting, for this set of experimental conditions, should be set at or near channel 39 for maximum detection sensitivity.

To test the effect of the upper-level discriminator setting, a cumulative total of the number of counts, with and without mine simulant targets, was calculated starting at channel 39. The detection signal, defined as the difference in number of counts between when a target is present and when it is absent, compared to the expected variance when the target is absent (this detection signal is expressed as n-sigma), for this set of experimental conditions, showed a distinct maximum at or near channel 160 for both time-tagged cases and cases in which time tagging is not used. For these experimental conditions, this maximum ranged from greater than 7% to greater than 12% more than the asymptotic value. This means that data above about channel 160 (FIG. 6c) add more noise than signal and should not be used. These data above about channel 160 contain more pulses arising from the interaction of more-energetic neutrons with the He-3 so this upper-level discrimination aids in discrimination against neutrons that have not interacted with hydrogen. This provides guidance that the upper-level discriminator setting, for this set of experimental conditions, should be set at or near channel 160 for maximum detection sensitivity.

### EXAMPLE 3

A series of computer experiments specifically for testing the efficacy of a window in the present invention, but also providing information about the optimal time delay, if used in a time delay-only mode, were performed using a computer model of the present invention. MCNP (Monte Carlo N-Particle Transport Code System), version 4a, was used for modeling the behavior of neutrons in interaction with matter. The physics of neutron interactions is well understood and appropriately included in this code; to the extent that the essentials of the computer experiment are incorporated in the input to the code, MCNP will give statistically meaningful results. If a sufficient number of neutron histories are examined, the computer model answers will accurately predict the results of an actual physical experiment. In reality, MCNP results can be better tests of the pertinent physics than those for a physical experiment because, in all physical experimental arrangements, controlling stray neutrons is very difficult. Additionally, computer experiments can be free of the constraints imposed by a particular set of electronics and can assist in focusing on electronic improvements. The concept of using a window for further neutron discrimination was based on discovering, during laboratory and field experiments, that soil greater than 1 meter from the source affected the neutron measurements and the resulting hypothesis that, although the mass of soil moisture distant from the source can be very great, its influence can be reduced by cutting off measurements for times such that thermal neutrons traveling more than a few 10 s of cm are not counted. That is, these experiments showed that the optimal time delay depends on soil conditions and, in addition, when hydrogen content, in particular soil moisture, increases, the use of a window would likely improve the signal-to-noise ratio. The use of a window would reduce the effect of soil hydrogen at a great distance from the source and sensor.

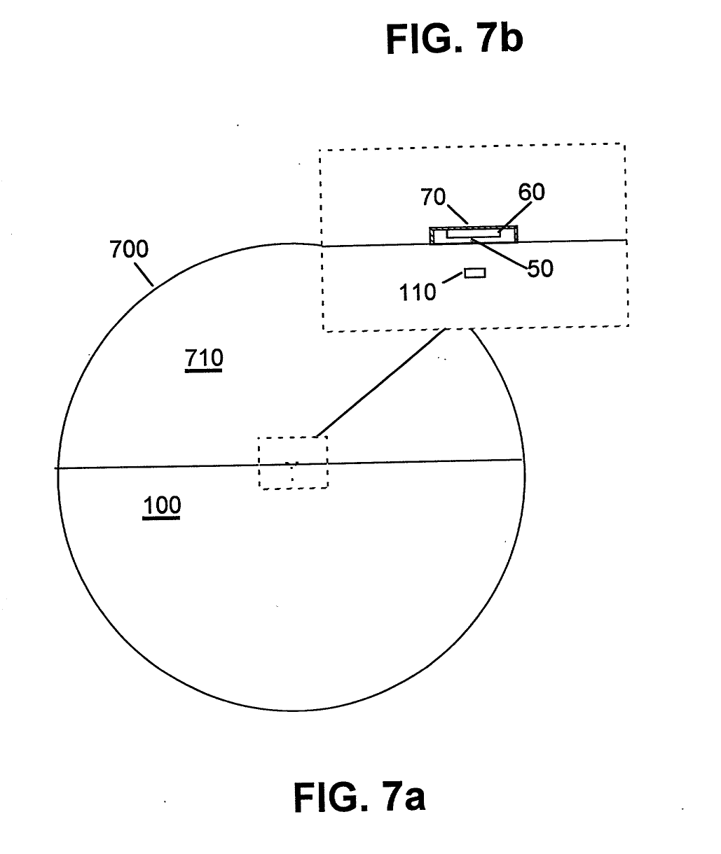

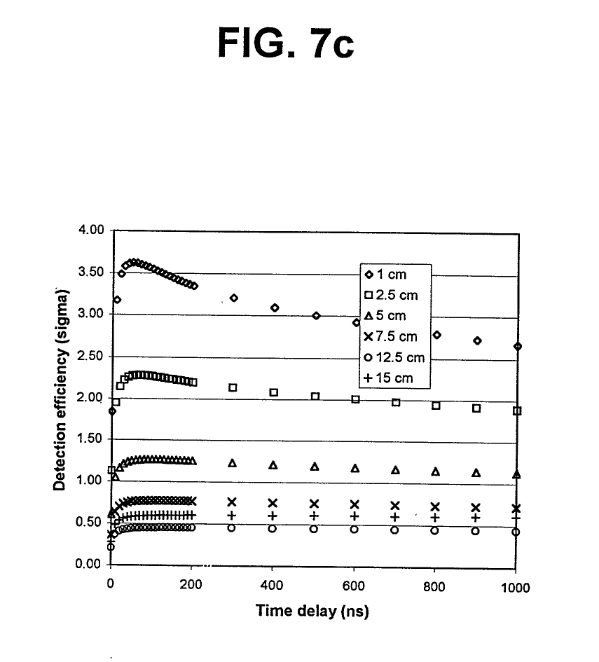

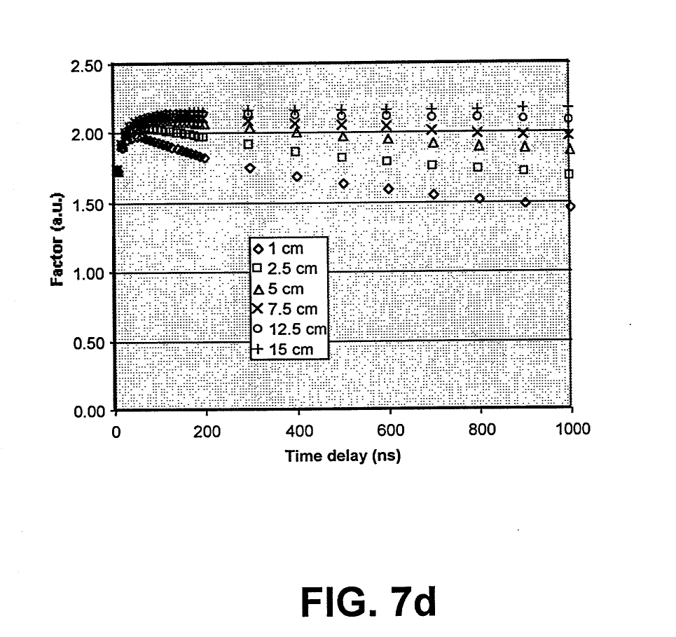

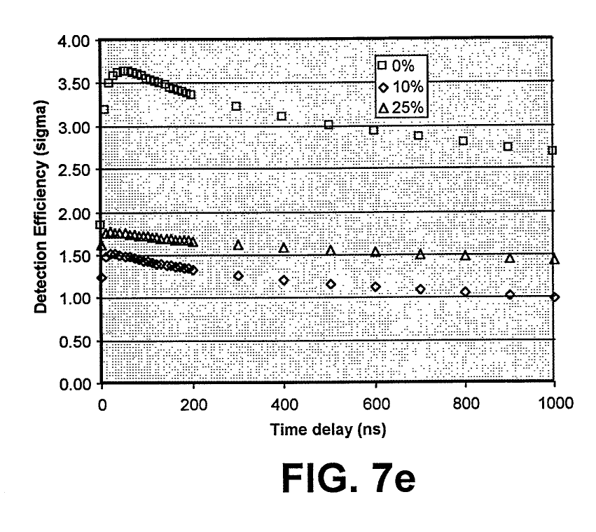

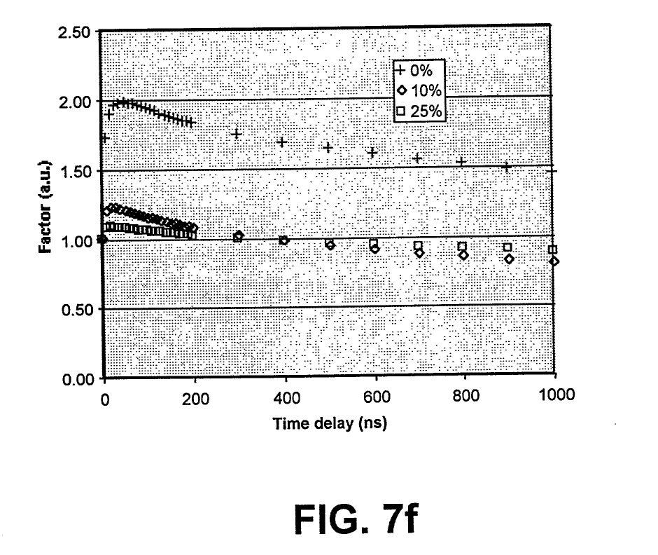

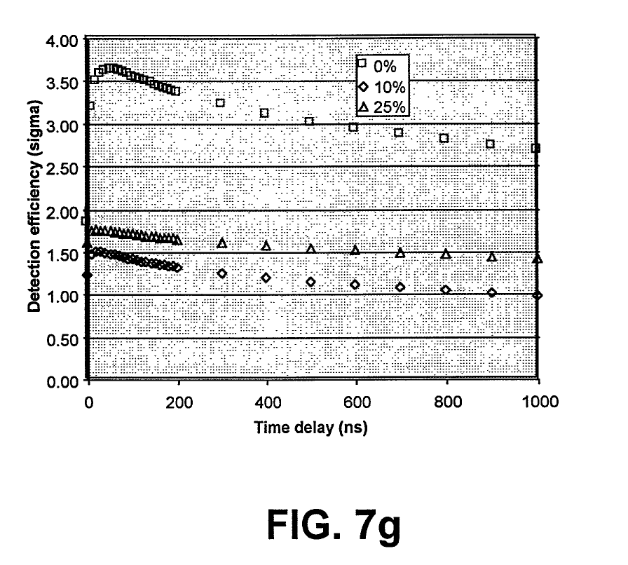

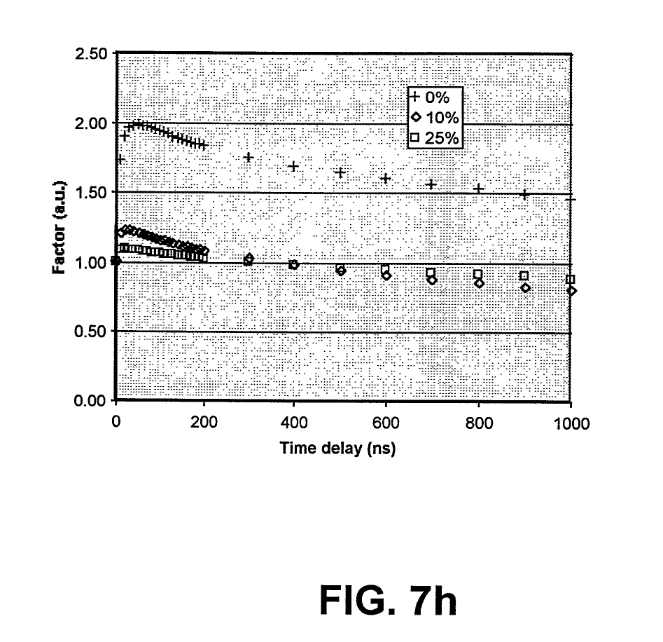

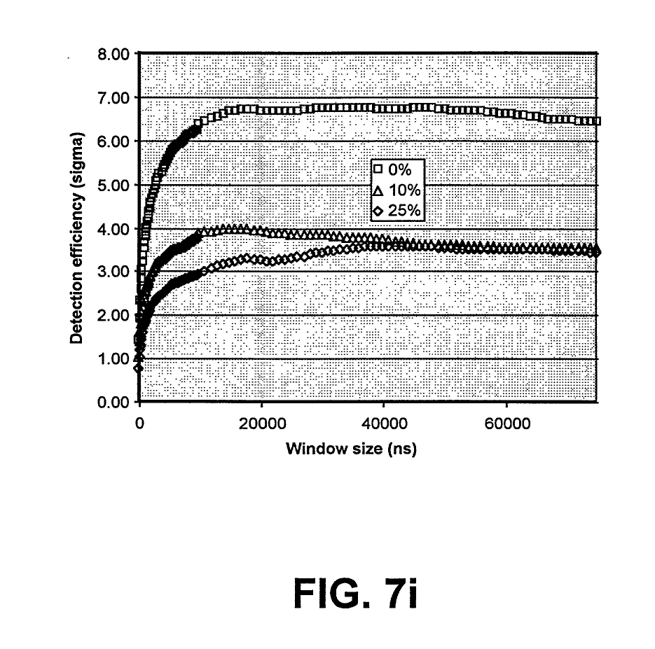

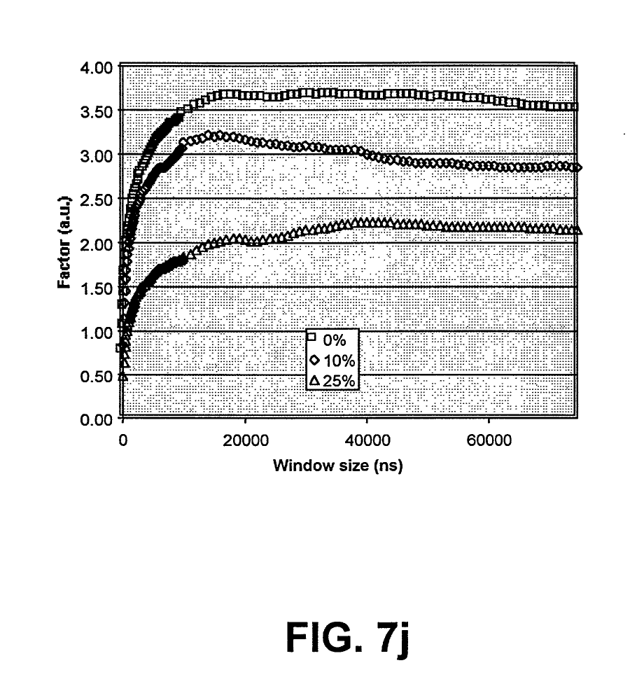

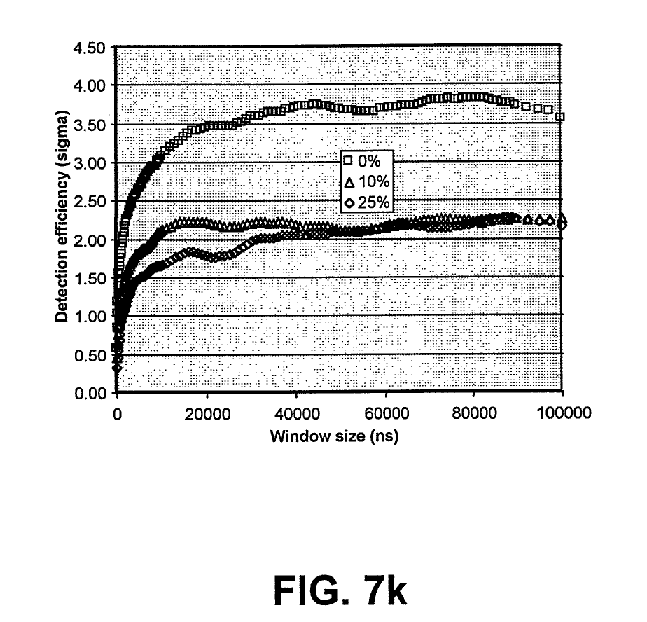

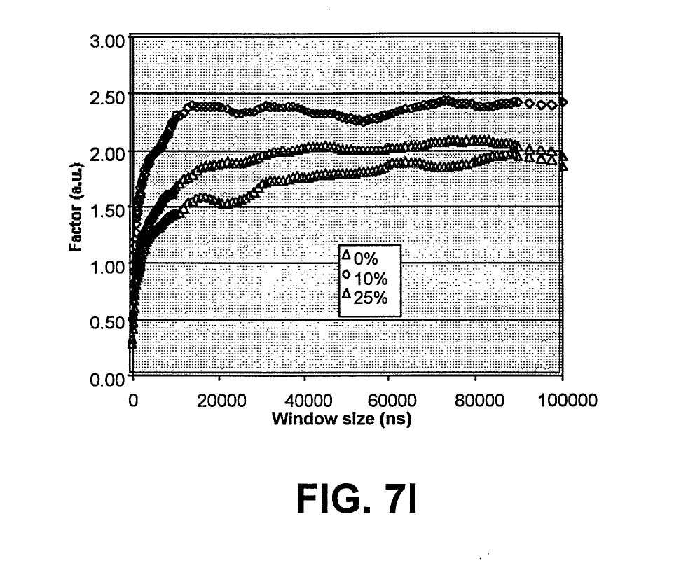

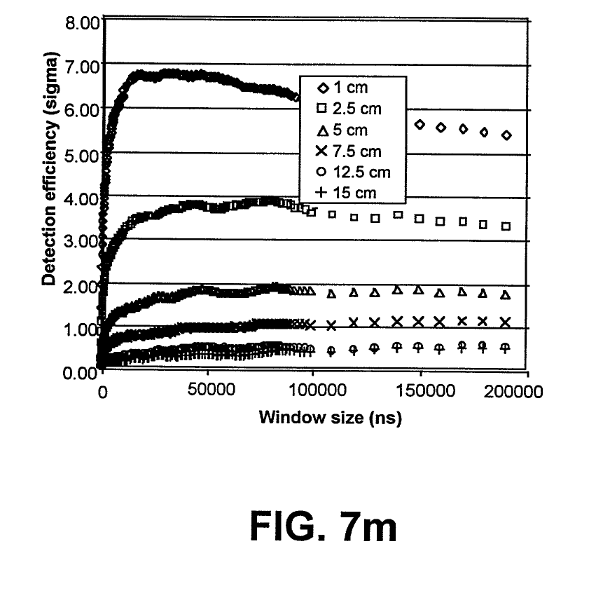

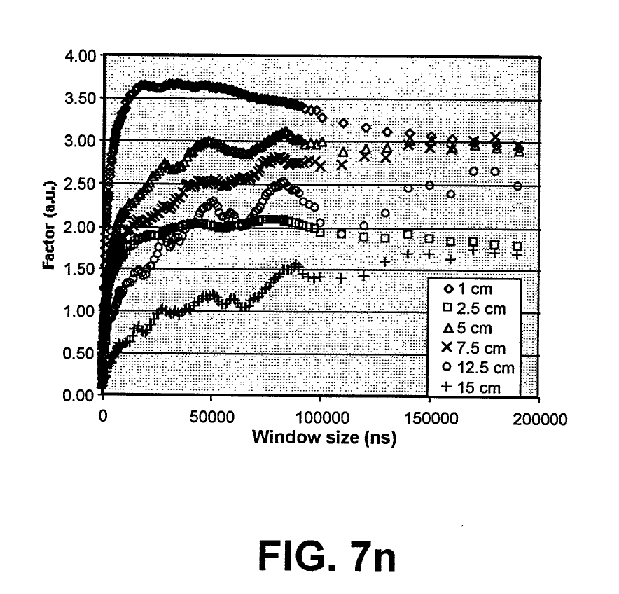

The computer model used in the series of computer experiments, shown in FIGS. 7a-b, consisted of a 10-meter diameter spherical universe 700. This sphere was divided equally into two parts: a low-density atmosphere 710 and ground 100. The ground 100 simulated soil having a mixture of SiO₂ (70%) and void space (30%). The SiO₂ was taken to have a specific gravity of 2.20; the void space can be filled with varying fractions of water, representing soil with varying degrees of saturation. The source 50 was located 1 cm above the surface of the geometric center of the sphere. The detector 60, representing a 0.4053 megaPascal ³He detector, was in the form of a 2.5-cm thick, 15-cm diameter cylinder and was located with its lower surface 1.5 cm above the soil. The neutron shield 70 was a 1-cm thick boron layer of unit density and surrounded the top and sides of the detector 60. The target 110, intended to represent a mine, was a 100-g, 5.75-cm diameter, 2.5-cm thick piece of material with the chemical composition C₃H₆N₆O₆, intended to represent RDX, a commonly used explosive. This series of experiments was intended to represent a very difficult-to-detect target.

These computer experiments consisted of following the history of 5,000,000 neutrons, a number found sufficient to give statistically meaningful results, emitted with a ²⁵²Cf spectrum, recording the time interval during which an interaction occurred in the detector for two cases: the target absent and the target present. The times that were studied covered a very wide range beginning with the emission of the neutron with 10-ns time bins for short times, increasing to 100 ns, then to 250 ns, and so on. This permits assessing the performance of the detector system for a wide variety of time delays and window sizes. These experiments were conducted for a variety of conditions: 1) soil moisture saturation of 0%, 10%, and 25% with the target at 1 and 2.5 cm below the surface and 2) target located 1, 2.5, 5.0, 7.5, 10.0, 12.5, 15.0, and 17.5 cm below the surface with 0% soil moisture saturation.

The data from the computer experiments were analyzed to determine: 1) the optimum time delay starting to count events and 2) the optimum window size to count. For the purpose of determining the optimum time delay, a total number of test neutrons of 367,000 was chosen; this number of neutrons provided a direct comparison with a one-second measurement with the equipment used in Example 1. For the analysis, the cumulative counts by the detector were determined as a function of the time delay in collecting counts without the target and with the target at various depths in the soil. From these, the detection efficiency was calculated for each time delay and compared to that with no time delay. The ratio of the detection efficiency with the time delay to that with no time delay is referred to as the improvement.

FIG. 7c shows the detection efficiency as a function of the time delay after the neutron emission for various target depths and for dry soil; FIG. 7d shows the relative improvement in detection efficiency, compared to the case in which there is no time delay for various target depths and for dry soil. The time delay for which detection efficiency is maximum varies in the range of 50 to 100 ns with target depth and the improvement in detection efficiency is on the order of a factor of 2, consistent with the laboratory experiment described in Example 1.

Similarly, FIGS. 7e-fshow the detection efficiency and relative improvement in detection efficiency, respectively, compared to the case in which there is no time delay for 1-cm target depths and 0%-, 10%-, and 25%-saturated soil. FIGS. 7g-h show the detection efficiency and relative improvement in detection efficiency, respectively, compared to the case in which there is no time delay for 2.5-cm target depths and 0%-, 10%-, and 25%-saturated soil. These data show, similar to those in FIGS. 7c-d, that time delays of 20 to 70 ns are optimal and the drier the soil and the shallower the target are, the shorter the optimal time delay. This means that, in operation for detection of targets, the time delay may be chosen specifically to match the degree of soil saturation and expected target depths or set at a single value of order 100 ns or less leading to slightly sub-optimal detection efficiency for some conditions.

For purposes of assessing the effect of varying the window size after the time delay, a time delay of 100 ns was chosen. The efficiency was calculated for various window sizes after after this time delay. This is compared with the efficiency obtained with the same time delay but with no window. The ratio of the windowed efficiency to the efficiency without a window is referred to as the improvement. The efficiency and improvements are shown in FIGS. 7i-j, as a function of window size for a 100-g disc of RDX 1 cm below the surface and in FIGS. 7k-l for 2.5 cm below the surface. FIGS. 7m-n show the efficiency and improvements for dry soil with the target at various depths below the surface.

These data show that for shallow targets, a window size of 20 μsec to 40 μsec (20,000 ns to 40,000 ns) provides a maximum in detection efficiency and improvements over detection efficiency in the absence of a window. Furthermore, when the target becomes more difficult to detect, whether because the target is deeper or because the soil contains more moisture, larger window sizes provide greater detection efficiency and improvements in efficiency.

### CLOSURE

While embodiments of the present invention have been shown and described, it will be apparent to those skilled in the art that many changes and modifications may be made without departing from the invention in its broader aspects. The appended claims are therefore intended to cover all such changes and modifications as fall within the true spirit and scope of the invention.

It is claimed:

1. An apparatus for detecting hydrogenous materials, comprising:
a. a time-tagged neutron source that provides a stream of fast neutrons directed toward a target;
b. at least one sensing head comprising a neutron sensor and a neutron shield, wherein a portion of said stream of fast neutrons is backscattered from said target to said neutron sensor that produces a neutron count signal dependent on the amount of hydrogenous material present in said target; and
c. a control system comprising a timing circuit, wherein said timing circuit disables said neutron sensor during a time delay beginning at the time said stream of fast neutrons is emitted from said neutron source and enables said neutron sensor after said time delay.

2. The apparatus as recited in claim 1, wherein said timing circuit enables said neutron sensor after said time delay during a window and disables said neutron sensor after said window.

3. The apparatus as recited in claim 1, wherein said control system further comprises a pulse-height analyzer with at least one pulse-height discriminator setting.

4. The apparatus as recited in claim 3, wherein said at least one pulse-height discriminator setting is an upper level discriminator setting.

5. The apparatus as recited in claim 1, wherein said neutron sensor is capable of spatially resolving said neutron count signal so that the location of said target can be determined.

6. The apparatus as recited in claim 5, wherein said neutron sensor comprises a collimating material.

7. The apparatus as recited in claim 5, wherein said neutron sensor comprises a coded-array aperture.

8. The apparatus as recited in claim 1, wherein said neutron source is selected from the group consisting of a fission source, an (alpha, n) source, a (gamma, n) source, and combinations thereof.

9. The apparatus as recited in claim 8, wherein said fission source comprises ²⁵²Cf.

10. The apparatus as recited in claim 1, wherein said neutron source is a neutron generator that is capable of being operated in pulse mode.

11. The apparatus as recited in claim 1, wherein said neutron sensor comprises a material selected from the group consisting of ³He, ¹⁰B, ⁶Li, and combinations thereof.

12. The apparatus as recited in claim 1, wherein said neutron sensor is selected from the group consisting of a ³He gas-proportional counter, a ¹⁰BF₃ gas-proportional counter, a scintillating glass containing ⁶Li, a scintillating glass containing ¹⁰B, a scintillating plastic containing ⁶Li, a scintillating plastic containing ¹⁰B, a scintillating crystal containing ⁶Li, a scintillating crystal containing ¹⁰B, and combinations thereof.

13. The apparatus as recited in claim 1, wherein said neutron shield comprises a material selected from the group consisting of ¹⁰B, ⁶Li, and combinations thereof.

14. The apparatus as recited in claim 1, further comprising an extension arm, one end of said extension arm connected to said sensing head and the other end of said extension arm connected to said control system.

15. The apparatus as recited in claim 1, further comprising a user interface wherein said user interface comprises a means for communicating said neutron count signal to a user.

16. A method for detecting hydrogenous materials comprising the steps of:
a. directing a stream of fast neutrons from a neutron source toward a target;
b. detecting the time when said stream of fast neutrons is emitted from said neutron source;
c. measuring a portion of said stream of fast neutrons that is backscattered from said target after a time delay beginning when said stream of fast neutrons is emitted from said source; and
d. communicating said measurement to a user.

17. The method as recited in claim 16, wherein said measuring occurs after said time delay and only during a window.

18. The method as recited in claim 16, further comprising the step of pulse-height discriminating said measurement.

19. The method as recited in claim 18, wherein said discriminating is performed using an upper level discriminator setting.

20. The method as recited in claim 16, wherein said target comprises an explosive.

21. The method as recited in claim 16, wherein said explosive is a land mine.

22. The method as recited in claim 16, wherein said explosive is unexploded ordinance.

23. The method as recited in claim 16, wherein said target is contraband narcotics.

24. The method as recited in claim 16, wherein said target is biological tissue.
